(19) United States
(12) Patent Application Publication
(10) Pub. No.: US 2015/0354771 A1
(43) Pub. Date: Dec. 10, 2015

(54) Vehicle Light Composite Lens

(71) Applicant: Yao Hung Huang, Rende Township (TW)

(72) Inventor: Yao Hung Huang, Rende Township (TW)

(21) Appl. No.: 14/301,165

(22) Filed: Jun. 10, 2014

(51) Int. Cl. F21S 8/10

(52) U.S. Cl. CPC F21S 48/1225; F21S 48/115; F21S 48/1241

(57) ABSTRACT

A vehicle light composite lens (VLCL) that features a segmented light lens (SLL) that is comprised of seven optical segments. The SLL is applied an LED light source that is processed through the seven optical segments to produce an optimum light beam that is projected onto a vehicle outside environment. The VLCL can be designed in various shapes and dimensions to accommodate various vehicle mounting segments and is adapted as an OEM vehicle product or as an after-market product.

### TECHNICAL FIELD

The invention generally pertains to external vehicle light assemblies, and more particularly to a vehicle light composite lens (VLCL) which features a segment light lens having a plurality of optical segments that in combination produce an optimum, light beam.

### BACKGROUND ART

All vehicles are equipped with at least a set of headlights and a set of tail lights to provide illumination for safe driving during inclement weather or evening and night driving. Since the days of using oil-lit vehicle lights there has been a desire to improve vehicle lights and especially to improve headlights.

The light improvements have primarily been concentrated on improving light bulbs and the reflected enclosure that surrounds the light bulb, with an emphasis being on utilizing light emitting diodes (LEDs). LEDs utilize less energy, have an extended useful life, are reliable and cost less than current incandescent light bulbs.

A search of the prior art did not disclose any patents or industry literature that read on the claims of the instant application.

### DISCLOSURE OF THE INVENTION

The vehicle light composite lens (VLCL) is designed to replace conventional vehicle light assemblies with an improved light source that produces an optimum vehicle light beam. The VLCL can be adapted for vehicle headlights, tail lights or side lights and can be utilized as an original equipment manufacturer (OEM) vehicles or as an after-market product.

In its basic design configuration the VLCL consists of:

A segmented light lens (SLL) having a plurality of optical sections that process the light that passes through the SLL to provide an optimum vehicle light beam,

At least one LED that interfaces with the right side of the SLL,

At least one LED that interfaces with the left side of the SLL,

Means for enclosing the SLL, and

Means for attaching the enclosed SLL to a vehicle light assembly structure.

The SLL in a preferred embodiment is comprised of seven interfacing optical sections that in combination produce the enhanced light beam. The SLL is enclosed in a protective frame that in turn, is attached to the vehicle light assembly structure.

In view of the above disclosure, the primary object of the invention is to provide a VLCL that is comprised of a combination of elements which are easily assembled to create a vehicle light beam that is visibly superior to currently available vehicle light sources that include headlights, tail lights and side lights.

In addition to the primary object of the invention it is also an object of the invention to provide a VLCL that:
increases the safety of driving a vehicle,
is easy to install,
can be produced in various dimensions and shapes,
can be designed to be used in various vehicles,
is reliable and easily maintained.
is durable and has a long useful life, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a cross-sectional view of a vehicle light composite lens (VLCL) showing a segmented light lens attached to a vehicle and a vehicle light switching circuit showing an LED prior to being attached to an LED socket.

FIG. 2 is a cross-sectional side view of a segmented light lens showing an LED prior to being inserted into a right and a left LED socket.

FIG. 3 is an elevational front view of an LED cluster. p FIG. 4 is an elevational side view of a segmented light lens configured as a square.

FIG. 5 is an elevational side view of a segmented light lens configured as a rectangle.

FIG. 6 is an elevational side view of a segmented light lens configured as a circle.

FIG. 7 is an elevational side view of a segmented light lens configured as an ellipse.

FIG. 8 is an orthographic front view of a VLCL having a set of three colored LED light assemblies attached to a typical vehicle attachment structure.

### BEST MODE FOR CARRYING OUT THE INVENTION

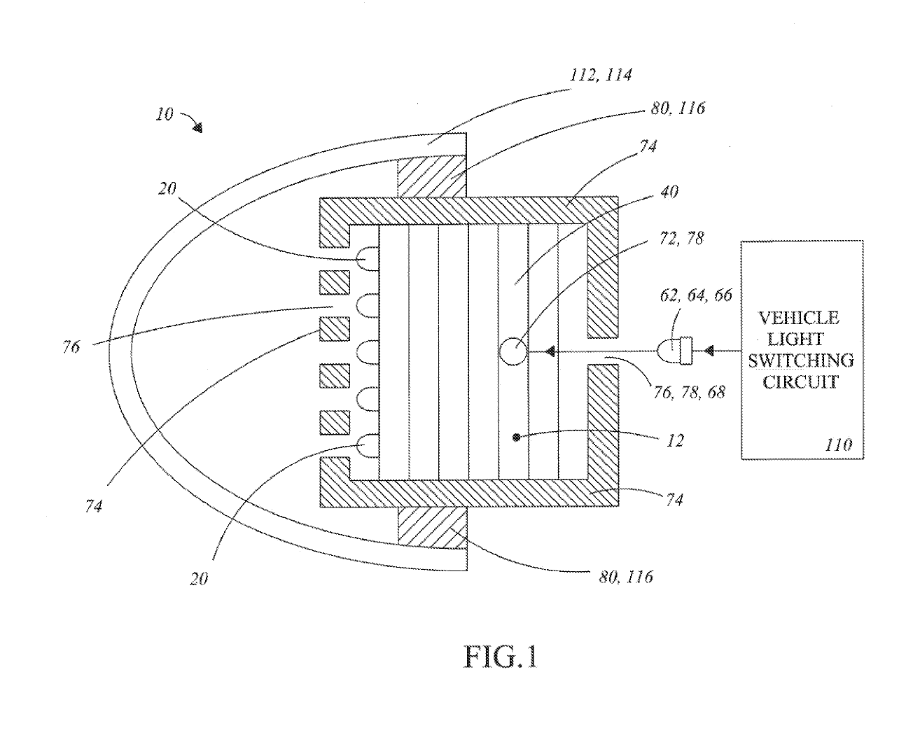

The best mode for carrying out the invention is presented in terms that disclose a preferred embodiment of a vehicle light composite lens (VLCL). The preferred embodiment of the VLCL 10, as shown in FIGS. 1-8, is comprised of a segmented light lens 12, at least one LED 62, at least one LED 64, means 74 for enclosing the segmented light lens 12, and means such as a bracket 80 for attaching the enclosed segmented light lens 12 to a vehicle. The VLCL 10 functions in combination with a vehicle having a light switching circuit 110, as shown in FIG. 1.

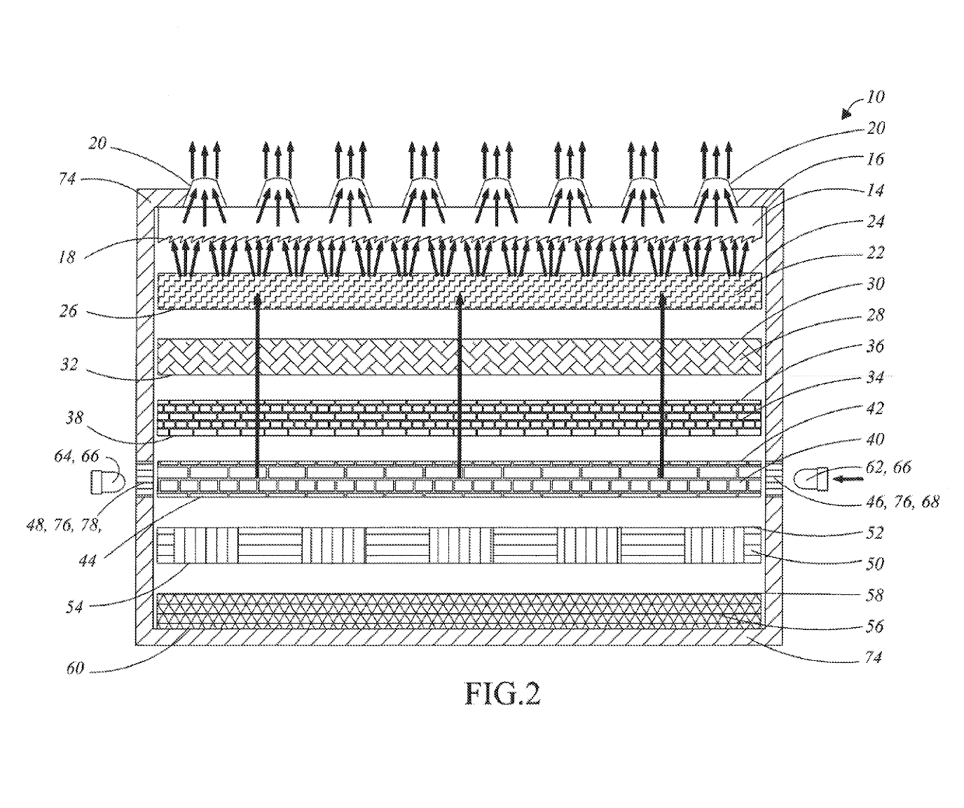

The segmented light lens 12, as shown in FIGS. 1 and 2, is comprised of a preferred design having seven segments that are described below and that are best shown in FIG. 2.

An outer panel board 14 has an outer surface 16, an inner surface 18 and a plurality of light directing lenses 20. The outer panel board 14 also has means for processing the developed light and projecting an optimum light beam via the lenses 20 onto an outside vehicle environment.

A first optical diffuser plate 22 has an outer surface 24 and an inner surface 26, wherein the outer surface 24 is located adjacent the inner surface 18 of said outer panel board 14. The first optical diffuser plate 22 also has means for receiving and diffusing the light applied from a prism sheet 28. The prism sheet 28 has an outer surface 30 and an inner surface 32, wherein the outer surface 30 is located adjacent the inner surface 26 of the first optical diffuser plate 22. The prism sheet 28 also has means for receiving the light passing through a second optical diffuser plate 34.

The second optical diffuser plate 34 has an outer surface 36 and an inner surface 38, wherein the outer surface 36 is located adjacent the inner surface 32 of the prism sheet 28. The second optical diffuser plate 34 also has means for diffusing light passing through a light guide plate 40. The light guide plate 40 has an outer surface 42, an inner surface 44, a right side LED attachment means 46, and a left side LED attachment means 48. The light guide pate 40 also has means for receiving the light from the LEDs 62,64 attached to the right and left side 46,48 of the light guide plate 40 and applying the light to the second optical diffuser plate 34.

A reflector 50 has an outer surface 52 and an inner surface 54, wherein the outer surface 52 is located adjacent the inner surface 44 of the light guide plate 40. The reflector 50 has means for reflecting the light scattered from the light guide plate 40 back to the light guide plate 40.

An aluminum plastic board 56 has an outer surface 58 and an inner surface 60, wherein the outer surface 58 is located adjacent the inner surface 54 of the reflector 50. The aluminum plastic board 56 functions as a reflector for reflecting scattered light into the light guide plate 40.

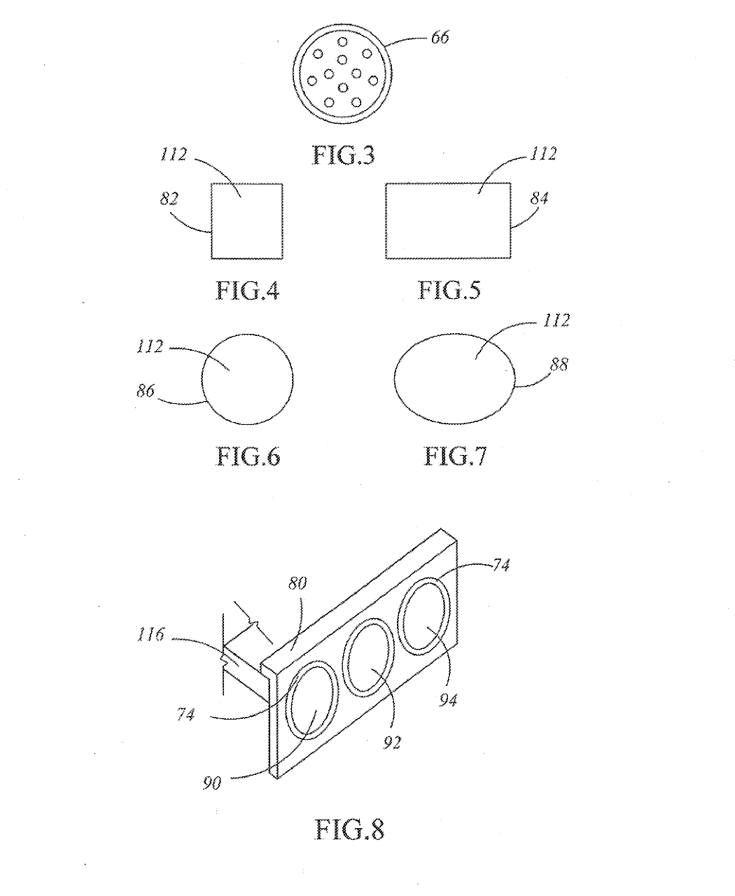

As shown best in FIG. 2, the illumination for the segmented light lens 12 is provided by at least one LED 62 that is inserted, via an LED projecting bore 76, into an LED socket 68 that interfaces with the right side of the light guide plate 40. Likewise at least one LED 64 is inserted, via an LED projecting bore 76, into an LED socket 78 located on the left side of the light guide plate 40. To enhance the light illumination provided by the LEDs 62,64, an LED cluster 66, as shown in FIG. 3, can be utilized. The segmented light lens 12 can be produced in a shape selected from the group consisting of a square 82, as shown in FIG. 4; a rectangle 84, as shown in FIG. 5; a circle 86, as shown in FIG. 6; and an ellipse 88, as shown in FIG. 7.

To add structural integrity to the segmented light lens 12, it is enclosed by an enclosing means such as a frame 74, as shown in FIGS. 1 and 2. The frame 74 includes on both the right and left sides, an LED projecting bore 76 which is in alignment with an LED attachment means 72 such as an LED socket 78, as shown in 1.

The frame enclosed segmented light lens 12 is mechanically connected to a vehicle light assembly 112 that includes a light globe 114 and a bracket mounting structure 116 that interfaces with a set of custom mounting brackets 80, as shown in FIGS. 1 and 2. The light lens 12 is electrically connected to a vehicle light switching circuit 110 that includes a set of electrical light outputs that operate an amber light signal when either a right turn or a left turn switch is activated. Likewise, a red light signal is produced when either a tail light or the brake light is activated, or a white light is produced when the vehicle is placed in a reverse direction.

A typical segmented light lens 12, as shown in FIG. 8, shows a bracket 80 having an amber light 90 located in the left side of the bracket 80, a centered red light 92 and right white light 94. For brevity, only a single light activation signal is shown in FIG. 8. Also, as shown in FIG. 2, the seven segments are shown spaced from each other to provide clarity for the referenced numbers.

While the invention has been described in detail and pictorially shown in the accompanying drawings it is not to be limited to such details, since many changes and modification may be made to the invention. without departing from the spirit and the scope thereof. Hence, it is described to cover any and all modifications and forms which may come within the language and scope of the claims.

1. A vehicle light composite lens (VLCL) comprising:
a) a segmented light lens (SLL) having a plurality of optical sections having a right side and a left side, wherein said optical sections enhance the quality of light that passes through said SLL to provide an optimum light beam,
b) at least one LED that interfaces with the right side of said SLL,
c) at least one LED that interfaces with the left side of said SLL,
d) means for enclosing said SLL, and
e) means for attaching the enclosed said SLL to a vehicle light assembly structure.

2. The VLCL as specified in claim 1 wherein said plurality of optical sections are comprised of seven optical sections.

3. The VLCL as specified in claim 2 wherein said seven optical sections are comprised of
a) a panel board having an outer surface, an inner surface and a plurality of light directing lenses,
b) a first optical diffuser plate having an outer surface and an inner surface, wherein the outer surface is located adjacent the inner surface of said outer panel board,
c) a prism sheet having an outer surface and an inner surface, wherein the outer surface is located adjacent the inner surface of said first optical diffuser plate,
d) a second optical diffuser plate having an outer surface and an inner surface, wherein the outer surface is located adjacent the inner surface of said prism sheet,
e) a light guide plate having an outer surface, an inner surface, a right side LED attachment means, and a left side LED attachment means,
f) a reflector having an outer surface and an inner surface wherein the outer surface is located adjacent the inner surface of said light guide plate, and
g) an aluminum plastic board having an outer surface and an inner surface, wherein the outer surface is located adjacent the inner surface of said reflector.

4. The VLCL as specified in claim 3 wherein said at least one LED is attached to each side of said light guide plate.

5. The VLCL as specified in claim 1 wherein said SLL can be produced in various dimensions and shapes.

6. The VLCL as specified in claim 5 wherein the shapes of said SLL are selected from the group consisting of a square, a rectangle, a circle and an ellipse.

7. The VLCL as specified in claim 1 wherein said at least one LED is comprised of an LED cluster.

8. The VLCL as specified in claim 1 wherein said SLL is comprised of three separate lenses, wherein a first lens utilizes an amber LED cluster, a second utilizes a red LED cluster and a third lens utilizes a white LED cluster.

9. A vehicle light composite lens (VLCL) comprising:
a) a segmented light lens (SLL) comprising:
(1) a panel board having an outer surface, an inner surface and a plurality of light directing lenses,
(2) a first optical diffuser plate having an outer surface and an inner surface, wherein the outer surface is located adjacent the inner surface of said outer panel board,
(3) a prism sheet having an outer surface and an inner surface, wherein the outer surface is located adjacent the inner surface of said first optical diffuser plate,
(4) a second optical diffuser plate having an outer surface and an inner surface, wherein the outer surface is located adjacent the inner surface of said prism sheet,
(5) a light guide plate having an outer surface, an inner surface, a right side LED attachment means, and a left side LED attachment means,
(6) a reflector having an outer surface and an inner surface wherein the outer surface is located adjacent the inner surface of said light guide plate,
(7) an aluminum plastic board having an outer surface and an inner surface, wherein the outer surface is located adjacent the inner surface of said reflector,
b) at least one LED that interfaces with the right side LED attachment means located on said light guide plate,
c) at least one LED that interfaces with the left side LED attachment means located on said light guide plate,
d) means for enclosing said segmented light lens, and
e) means for attaching said enclosed segmented light lens to a vehicle light assembly structure.

10. The VLCL as specified in claim 9 wherein said segmented light lens has a shape selected from the group consisting of a square, a rectangle, a circle and an ellipse.

11. The VLCL as specified in claim 9 wherein said plurality of lenses located on said outer panel board have means for gathering the light and projecting an optimum light beam onto an outside vehicle environment.

12. The VLCL as specified in claim 11 wherein said first optical diffuser plate having means for receiving and diffusing the light applied from said prism sheet.

13. The VLCL as specified in claim 13 wherein said prism sheet having means for receiving the light passing through said second optical diffuser.

14. The VLCL as specified in claim 13 wherein said light guide plate having means for receiving the light from said LEDs and applying the light to said second optical diffuser plate.

15. The VLCL as specified in claim 14 wherein said reflector having means for reflecting the light scattered from said light guide plate back to said light guide plate.

16. The VLCL as specified in claim 15 wherein said aluminum plastic board functions as a reflector having means for reflecting the scattered light into said light guide plate.

17. The VLCL as specified in claim 9 wherein said at least one LED is further comprised of an LED cluster.

18. The VLCL as specified in claim 9 wherein said LED attachment means comprises a socket that is attached to said light guide plate.

19. The VLCL as specified in claim 9 wherein said means for enclosing said segmented light lens comprises a frame that encompasses the edges of said segmented light lens.

20. The VLCL as specified in claim 13 wherein said means for enclosing said segmented light lens to a vehicle comprises a bracket.
